(19) United States
(12) Patent Application Publication
(10) Pub. No.: US 2007/0112672 A1
(43) Pub. Date: May 17, 2007

(54) Systems, Methods and Computer Program Products for Negotiation of Risk Transfer for Products

(76) Inventor: Ronald W. Helms, Chapel Hill, NC (US)

Correspondence Address: MYERS BIGEL SIBLEY & SAJOVEC, PO BOX 37428, RALEIGH, NC, 27627, US

(21) Appl. No.: 11/548,535

(22) Filed: Oct. 11, 2006

Related U.S. Application Data
(60) Provisional application No. 60/726,019, filed on Oct. 12, 2005.

(51) Int. Cl. G06Q 40/00

(52) U.S. Cl. 705/40

(57) ABSTRACT

A product risk acceptance contract (PRAC) system server communicates with a PRAC system provider client coupled thereto and responsively generates a record of an offer for a risk transfer for a product (e.g., a good, intangible asset and/or service). The PRAC system server further communicates with a PRAC system consumer client coupled thereto and responsively generates a record of an executed PRAC for the product based on the generated record of the offer for the risk transfer.

### RELATED APPLICATION

The present application claims the priority of U.S. Provisional Application No. 60/726,019, entitled “Product Risk Acceptance System and Method,” filed Oct. 12, 2005, the disclosure of which is hereby incorporated by reference in its entirety.

### BACKGROUND OF THE INVENTION

The present invention relates generally to risk management systems, methods and computer program products and, more particularly, to systems, methods and computer program products for management of risks associated with products and/or services.

Many products sold in the U.S. carry inherent risks for the users. For example, the Food and Drug Administration (FDA) licenses many medications for sale by prescription only, often because the use of the medication carries the risk of untoward health events or conditions, even when the medication is used properly. As another example, even when used properly, many types of sports equipment carry inherent risk of injury or even death. These are just two classes of products that carry inherent risks, and there are many others.

Many services sold or provided in the U.S. also carry inherent risks for those who receive the services. For example, many types of surgery, even when properly performed, without error, may have a poor outcome for reasons beyond the control of the surgeon and healthcare givers. This is just one class of services that carries inherent risk; there are many others.

A combination of product(s) and services(s) may carry inherent risks for the consumer. For example, a company that trains people to function in certain types of sports (skiing, scuba diving, sky diving) may provide both the training and the necessary equipment. Even when the training is conducted properly and the equipment functions properly, there is a risk of injury to the student. For another example, a surgeon may implant a device (e.g., a pacemaker) in a consumer. Obviously the implantation is a service and the device is the product. Even when the surgery is performed properly and the pacemaker functions properly there is a possibility of injury (e.g., heart attack) to the consumer. These are just two classes of product-service combinations that carry inherent risk; there are many others.

Class action and individual product liability or service related lawsuits may cost manufacturers, sellers, and service providers large amounts of money each year. Beyond the dollar amounts involved, the magnitudes of such suits are often unpredictable due to variations among forums, evidentiary issues and the like.

In addition, some products and services have largely unknown risk profiles. For example, the FDA often approves pharmaceutical products for sale on the basis of safety data from a few thousand patient-years' experience, some of which may not be at the highest approved dose. There is a possibility that such a product, although properly used based on information gleaned from clinical studies, may produce important adverse events in an average, for example, of once in every 10,000 patient-years' experience, or once per 100,000 patient-years. Detecting such low adverse event rates may require far more subjects than are enrolled in the clinical trials typically required for drug approval. Thus, even though the product meets the FDA's criteria for demonstration of “safety and efficacy,” there is a possibility that the product has safety issues that are as yet undetected, problems that cannot be detected until after the product has been approved and marketed to large numbers of patients.

### SUMMARY OF THE INVENTION

Some embodiments of the present invention provide methods of supporting risk management for products, where “products” encompasses goods, intangible assets and/or services. A product risk acceptance contract (PRAC) system server communicates with a PRAC system provider client coupled thereto and responsively generates a record of an offer for a risk transfer for a product. The PRAC system server further communicates with a PRAC system consumer client coupled thereto and responsively generates a record of an executed PRAC for the product based on the generated record of the offer for the risk transfer. The risk transfer may include, for example, a waiver of legal remedy, a limitation on damages, a constraint on legal process, an indemnity or other mechanisms for transfer of legal responsibility for adverse events associated with use of the product. PRAC execution may occur concomitant with sale of the product, or in a temporally separate transaction.

Communication with the PRAC system consumer client and responsively generating a record of an executed PRAC may include transmitting information describing the offer for a risk transfer to the PRAC system consumer client, subsequently receiving risk transfer acceptance information from the PRAC system consumer client and generating the record of the executed PRAC responsive to receipt of the risk transfer acceptance information. Transmission of information describing the offer of a risk transfer is preceded by receiving information from the PRAC system consumer client identifying at least one candidate product, identifying the record of the offer for a risk transfer based on the identified candidate product and generating the information describing the offer for a risk transfer responsive to identification of the offer for a risk transfer. The information describing the offer for a risk transfer may include information describing consideration associated with acceptance of the offer, such as a discount, a surcharge, a rebate and/or acquisition under more favorable or less favorable terms.

In some embodiments the information describing the offer for a risk transfer may include information identifying a known type of potential adverse event associated with the product, and the risk transfer may include a waiver of a legal remedy for the identified type of potential adverse event. In further embodiments, the information describing the offer for a risk transfer may include information identifying a known type of potential adverse event associated with the product, and the risk transfer may include a waiver of a legal remedy for an unidentified type of potential adverse event associated with the product. In yet further embodiments, the information describing the offer for a risk transfer may include information identifying a type of potential adverse event associated with the product known from regulatory agency mandated testing of the product, and the risk transfer may include a waiver of a legal remedy for a type of potential adverse event unidentified by regulatory agency mandated testing of the product.

According to further embodiments of the present invention, communicating with a PRAC system provider client coupled to the PRAC system server and responsively generating a record of an offer for a risk transfer for a product of a provider may include receiving PRAC term information (e.g., information describing risk transferred by the PRAC and consideration provided in return) from the PRAC provider client and generating a PRAC template based on the received PRAC term information. Communicating with a PRAC system consumer client coupled to the PRAC system server and responsively generating a record of an executed PRAC for the product based on the generated record of the offer for a risk transfer may include receiving PRAC component information from the PRAC system consumer client and entering the received PRAC component information into the PRAC template.

According to further embodiments, communicating with a PRAC system provider client coupled to the PRAC system server and responsively generating a record of an offer for a risk transfer for a product of a provider may be preceded by communicating with a PRAC system provider client to enroll the provider in a PRAC service. Communicating with a PRAC system consumer client coupled to the PRAC system server and responsively generating a record of an executed PRAC for the product based on the generated record of the offer for a risk transfer may be preceded by communicating with a PRAC system consumer client to enroll the consumer in the PRAC service.

Communicating with a PRAC system consumer client to enroll the consumer in the PRAC service may be preceded by receiving information from the PRAC system consumer client identifying at least one candidate product and identifying the record of the offer for a risk transfer as corresponding to the identified candidate product. Communicating with the PRAC system consumer client to enroll the consumer in the PRAC service may include communicating with a PRAC system consumer client to enroll the consumer in the PRAC service responsive to identification of the record of the offer for a risk transfer as corresponding to the identified candidate product. Communicating with a PRAC system consumer client coupled to the PRAC system server and responsively generating a record of an executed PRAC for the product based on the generated record of the offer for a risk transfer may include receiving validation information from the PRAC system consumer client and generating the record of the executed PRAC responsive to the validation information. The validation information may include, for example, biometric information associated with the enrolled consumer, account information associated with the enrolled consumer and/or information associated with an enrolled validator for the PRAC service.

In some embodiments, communicating with a PRAC system consumer client coupled to the PRAC system server and responsively generating a record of an executed PRAC for the product based on the generated record of the offer for a risk transfer may include communicating with the PRAC system consumer client and responsively generating a record of the executed PRAC concomitant with sale (erg., outright or partial purchase, lease, rental or other transaction) of the product. In some embodiments, communicating with a PRAC system consumer client coupled to the PRAC system server and responsively generating a record of an executed PRAC for the product based on the generated record of the offer for a risk transfer may include communicating with the PRAC system consumer client and responsively generating a record of the executed PRAC concomitant with provision of a payment and/or credit to the consumer.

According to further aspects of the present invention, methods may further include monitoring and/or controlling use of the product in accordance with the executed PRAC. For example, the product may have a PRAC monitor associated therewith that is configured to monitor and/or control the product to provide compliance with a PRAC.

Further embodiments of the present invention provide an apparatus including a computer configured to perform the above-described operations. Additional embodiments provide a computer program product including computer program code embodied in a storage medium, the computer program code including program code configured to perform the above-described operations.

In some embodiments of the present invention, a product risk acceptance contract (PRAC) system client receives information describing an offer for a risk transfer for a product of a provider from a PRAC system server coupled to the PRAC system consumer client and, responsive to the received information describing an offer for a risk transfer, communicates with the PRAC system server to support generation of a record, accessible via the PRAC system server, of an executed PRAC for the product. In still further embodiments of the present invention, a product risk acceptance contract (PRAC) system provider client communicates with a PRAC system server coupled to the PRAC system provider client to support generation of a record, accessible via the PRAC system server, of an offer for a risk transfer for a product.

In accordance with further embodiments of the present invention, a product risk acceptance contract (PRAC) monitor controls and/or monitors operation of the product responsive to a PRAC for the product. The PRAC monitor may, for example, communicate with a PRAC system server over a communications network and/or operate responsive to a portable memory device, such as a smart card or USB flash key, that stores information relating to a PRAC, which may, for example, be downloaded from a PRAC system server to the portable memory device.

### BRIEF DESCRIPTION OF THE DRAWINGS

FIG. 1 is a schematic diagram illustrating a PRAC system architecture according to some embodiments of the present invention.

FIG. 2 is a schematic diagram illustrating communications between a PRAC system provider client and a PRAC system server according to some embodiments of the present invention.

FIG. 3 is a schematic diagram illustrating communications between a PRAC system consumer client and a PRAC system server according to some embodiments of the present invention.

FIG. 4 is a schematic diagram illustrating an arrangement of a PRAC system database according to some embodiments of the present invention.

FIG. 5 is a schematic diagram illustrating a client/server implementation of a PRAC system according to some embodiments of the present invention.

FIG. 6 is a flowchart illustrating exemplary operations of the system of FIG. 5.

FIG. 7 is a schematic diagram illustrating another client/server implementation of a PRAC system according to some embodiments of the present invention.

FIG. 8 is a flowchart illustrating exemplary operations of the system of FIG. 7.

FIG. 9 is a flowchart illustrating exemplary operations for establishing a PRAC service according to some embodiments of the present invention.

FIG. 10 is a flowchart illustrating exemplary operations for creating and executing a PRAC using a PRAC service according to further embodiments of the present invention.

FIG. 11 is a schematic diagram illustrating an implementation of a PRAC system including a PRAC monitoring capability according to some embodiments of the present invention.

FIG. 12 is a flowchart illustrating exemplary operations of the system of FIG. 11.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items. As used herein the personal pronouns “he” and “she” each refer to one or more persons of either gender.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, apparatus, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the pro-ram is printed, as the program can be electronically captured, via, for instance, optical scanning of the paper or other medium, then compiled, interpreted, or otherwise processed in a suitable manner, if necessary, and then stored in a computer memory.

Some embodiments of the present invention arise from a realization that a product manufacturer, product reseller, sales agent or other goods or services provider (hereinafter “provider”) of one or more products can enter into a legally enforceable, electronically stored contract with a purchaser, purchasing agent or the like (hereinafter “consumer”) under which the consumer agrees to accept financial and other responsibility for adverse events associated with the product. The purchaser's “risk acceptance” may include, for example, a complete waiver of remedy for damages associated with use of the product, a partial waiver of remedy, such as a damages cap or waiver of certain types of remedies (e.g., remedies for pain and suffering), and/or an indemnity of the provider against claims from subsequent purchasers of the product. As used herein, “product” refers to any good (e.g., wares, merchandise, etc.), intangible asset (e.g., negotiable instruments, intellectual property, etc.) and/or service manufactured, sold, distributed or otherwise provided, alone or in combination with other goods, intangibles and/or services. As used herein, “adverse events” include death, injury, loss of value and/or other damages or harm.

In some embodiments of the present invention, a product risk acceptance contract (PRAC) system, such as a system for negotiating transfer of risk associated with use of goods, such as a prescription or non-prescription drug, a medical device or potentially hazardous machinery (e.g., an aircraft, a vehicle, a piece of industrial equipment or the like), an intangible asset, such as a financial instrument, and/or service, includes a PRAC system server configured to communicate with PRAC system provider clients to generate electronic records of offers for liability transfer, which may be stored in a database maintained by a PRAC system provider. A PRAC system consumer client may interact with the PRAC system server to access the liability transfer offers and may exchange communications with the PRAC system server to generate electronic records of executed PR-ACs. The PRAC system may, among other things, provide for authentication of the PRAC system consumer client through, for example, biometric identification and electronic signature techniques. The PRAC system may provide a repository of PRAC records that may be accessed to obtain authenticated evidence for use in, for example, legal proceedings and/or arbitration.

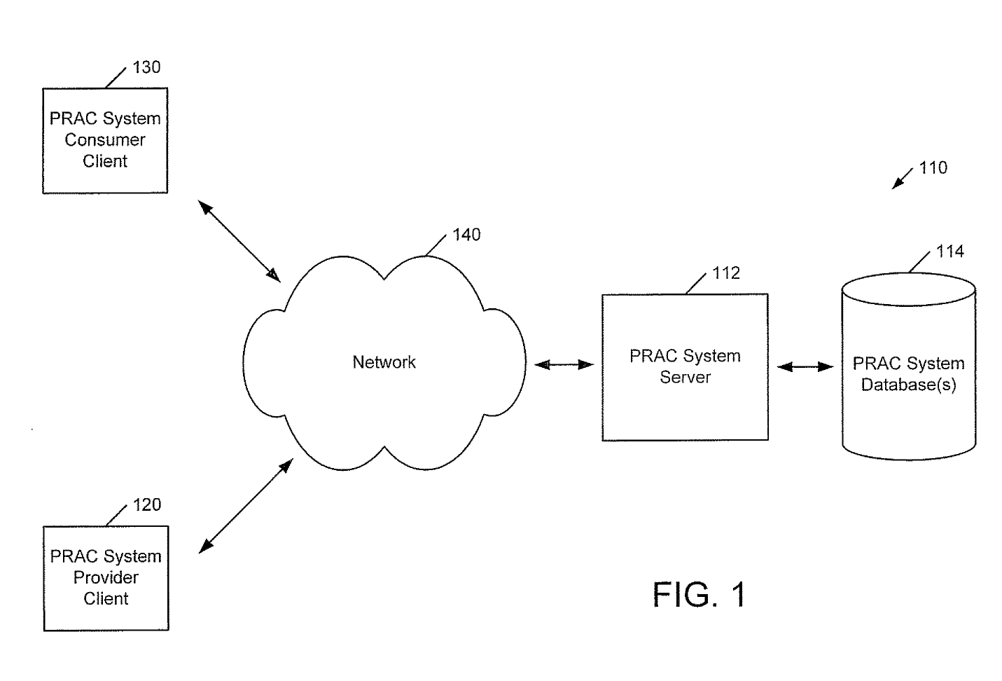

FIG. 1 illustrates a PRC system client-server architecture according to some embodiments of the invention. A PRAC system 110 includes a PRAC system server 112 and a PRAC system database 114. Generally, the PRAC system server 112 is configured to maintain the PRAC system database 114 responsive to interactions with at least one PRAC system provider client 120 and at least one PRAC system consumer client 130 over a network 140. In various embodiments of the present invention, the PRAC system server 112 may store product information and records of offers for risk transfer received from the provider client 120, and may convey such information to the consumer client 130 and interact therewith to generate an executed PRAC, which may also be stored in the PRAC database 114.

It will be appreciated that the server 112, provider client 120 and consumer client 130 may be implemented in any of a number of different ways. For example, the server 112 may implemented in a single server computer, or may be distributed across multiple devices, whether in a single server farm or across multiple geographic locations. The provider and consumer clients 120, 130 may, for example, be implemented using respective different software applications, or may be parts of a generic “user client” application that may be used by provider and/or consumer terminals and which generally provides access to the PRAC server 112. Such a user client may, for example, provide different provider and consumer client functionality depending upon whether the user is a provider or a consumer. Such functionality may include a common user interface, such as an internet browser-based interface and/or may include separate user interfaces based on whether provider or consumer functionality is being provided. Such functionality may be controlled, for example, based on user identification information input into the user client. Such functionality may be controlled, locally or may be controlled by the server 112.

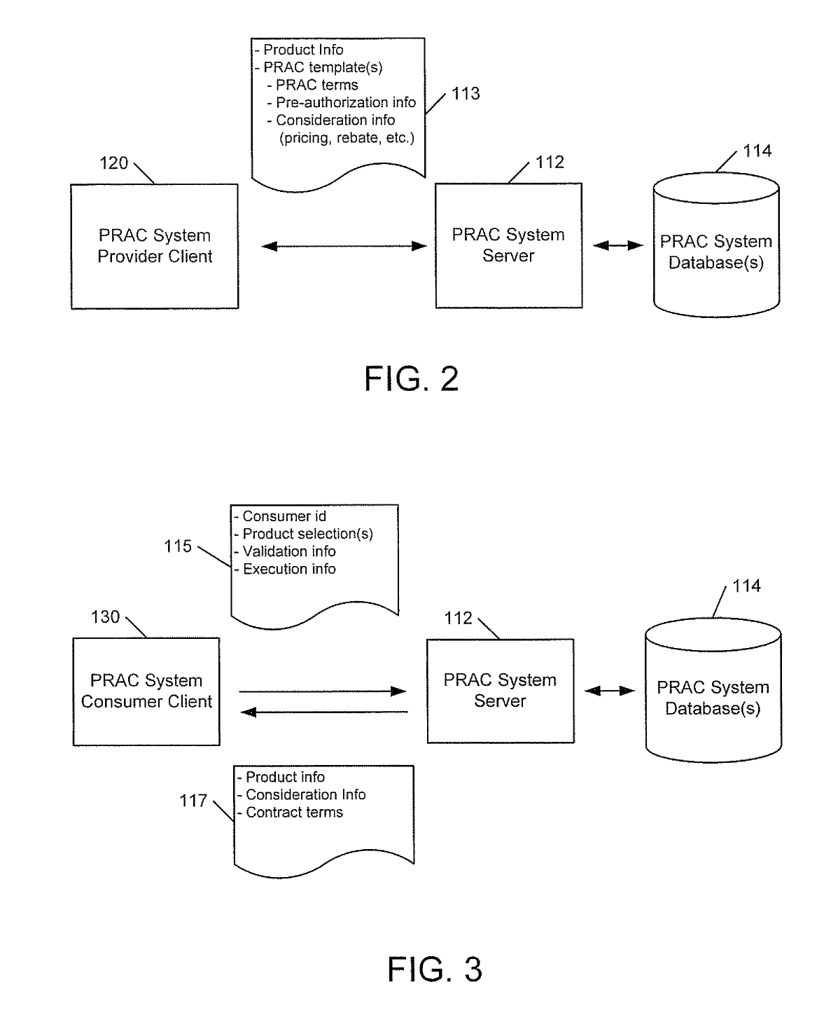

FIG. 2 illustrates examples of the types of information that may be communicated between the PRAC system server 112 and the PRAC system provider client 120. The PRAC system provider client 120 may submit information 113 to, and/or retrieve information 113 from, the RAC database 114 via the PRAC system server 112. The PRAC system provider client 120 may use revised information 113 to update, modify, or replace information previously stored in the RAC system database 114 via the PRAC system server 112. Information 113 transmitted between the PRAC system server 112 and the PRAC system provider client 120 may be product information, such as product identification info and product specification information, such as size, weight and content information. Such information may be provided directly to the PRAC system server 112, or may be indirectly provided by supplying, for example, a link to a website or other network location that may provide the information. The information 113 may further include information that defines a “PRAC template”, such as information that defines generic contract terms, information defining the scope of pre-authorization that the PRAC system may have to enter into and execute PRACs on behalf of the provider, and pricing or other consideration information associated with PRACs for the identified products, but that may not include, for example, specific components for a specific transaction, such as the identities of the contract parties. As shown, the PRAC system server 112 may store this information in the PRAC system database 114.

FIG. 3 illustrates examples of types of information that may be communicated between the PRAC system server 112 and the PRAC system consumer client 130. Information 115 transmitted from the consumer client 130 to the server 112 may include, for example, consumer identification information, information identifying consumer product selections, validation information (e.g., account information, purchase authorization information), and contract execution information (e.g., electronic signature or other authentication of intent to enter a contract). As shown, this information may be stored in the PRAC system database 114. Information 117 that may be communicated from the PRAC system server 112 to the consumer client 120 may include information on products available for coverage under a PRAC, contract terms for proposed PRACs, and consideration information (e.g., pricing, discounts, rebates, etc.) offered for entry into PRACs for the products. As shown, this information may be retrieved from the PRAC system database 114.

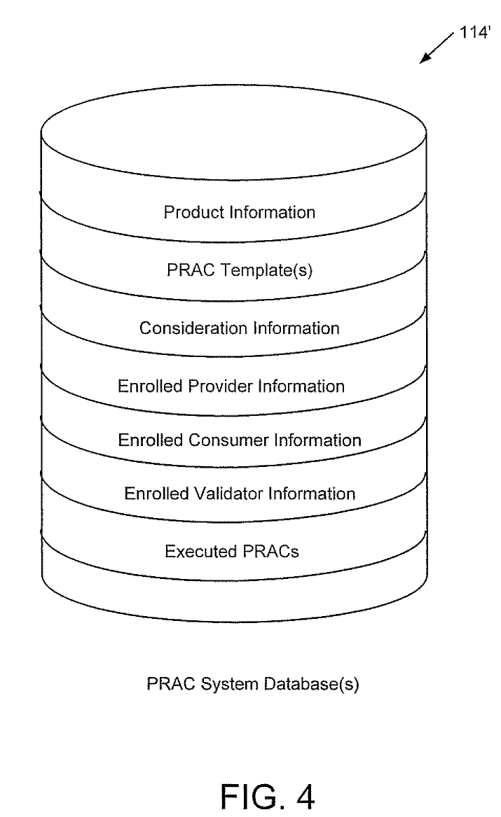

FIG. 4 illustrates an exemplary configuration of a PRAC system database 114′ according to some embodiments of the present invention. The PRAC system database 114′ may store, for example, product information, PRAC templates, consideration information, provider information, consumer information, information pertaining to third party validators (e.g., pharmacists, dealers, resellers, etc.) that may be involved in PRAC execution, and information describing and authenticating executed PRACs. It will be appreciated that a PRAC system database may be implemented using any of a number of different types of database structures, including, but not limited to, databases following relational, hierarchical, network and object database models. Generally, a PRAC database may be implemented in a single storage device or distributed over multiple devices in, for example, a networked configuration.

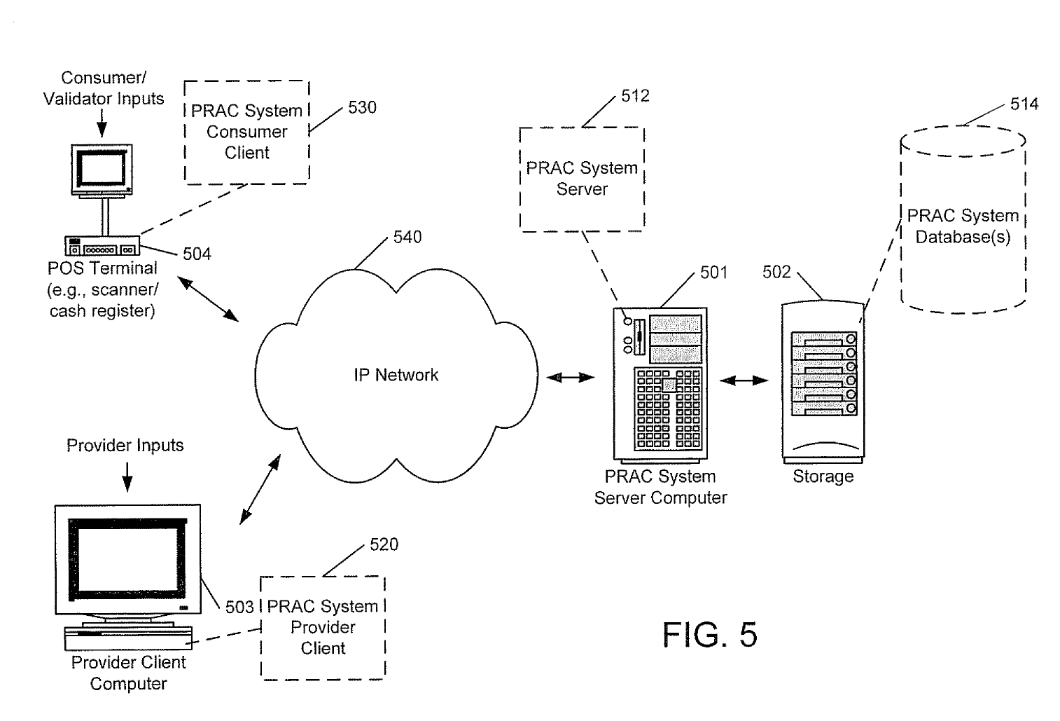

FIG. 5 illustrates an exemplary implementation of a PRAC system that may be particularly advantageous, for example, in implementations in which a PRAC is executed or modified concurrent with the purchase of a product covered by the PRAC. A PRAC system server 512 is implemented in a server computer 501, which is operatively associated with a data storage device 502 (e.g., a disk drive array) that stores a PRAC database 514. A point of sale (POS) terminal 504 is coupled to the PRAC server computer 501 by an IP network 540, and has a PRAC system consumer client 530 resident thereat. The POS terminal 504 is configured to provide a man-machine interface for a consumer and/or a third party validator or other agent at the point of sale. A provider computer 503, such as a desktop PC, workstation, laptop computer or the like, is coupled to the IP network 540 and has a PRAC system provider client 520 resident thereat. The PRAC system provider client 520 may be configured to provide a man-machine interface for a provider or a provider agent, such as an employee or authorized contractor, to perform and/or support provider client functions as described herein and/or to perform and/or support all or some of such provider client functions automatically without user intervention.

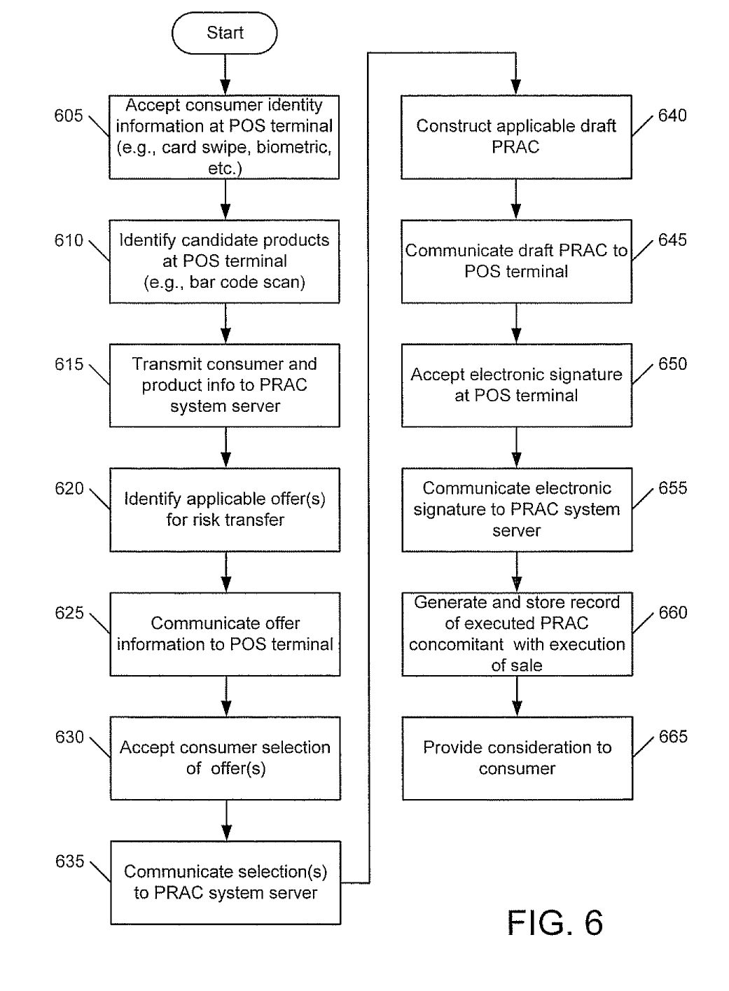

FIG. 6 illustrates exemplary operations for entry into a PRAC using such a structure according to some embodiments of the present invention. Consumer identity information is accepted at the POS terminal 504 (block 605). The information may be entered using, for example, a card swipe, biometric input (e.g., fingerprint or retinal scan), and/or entry of username and password. Such information may be used, for example, to determine whether the consumer is enrolled in PRAC service or otherwise authorized to enter into PRACs. One or more candidate products for a PRAC are identified at the POS terminal 504, e.g., by bar code scan, RFID, or other techniques (block 610).

Consumer identification and product information are transmitted by the PRAC system consumer client 530 at the POS terminal 504 to the PRAC system server 512 at the server computer 501 (block 615). The PRAC system server 512 identifies one or more applicable offers for risk transfer resident in the PRAC database 514 (block 620), and communicates information about the offer(s) to the PRAC system client 530 at the POS terminal 504 (block 625).

At the POS terminal 504, the consumer 530 selects the offer(s) that she wishes to accept (block 630). The selection(s) are then communicated back to the PRAC system server 512 (block 635), which constructs an appropriate PRAC, e.g., by drafting a new proposed PRAC using a PRAC template or drafting a proposed modification of an existing PRAC (block 640). Information describing the proposed PRAC is then communicated back to the PRAC system consumer client 530 (block 645), where the consumer may formally accept the agreement by an appropriate authenticated process, such as a electronic signature (block 650). The evidence of formal acceptance may then be communicated to the PRAC system server 512 (block 655), which may responsively generate a retrievable electronic record of the executed PRAC (block 660). Consideration for the PRAC may be provided to the consumer, for example, by applying appropriate discounts and/or surcharges at the PRAC consumer client 530 (block 665).

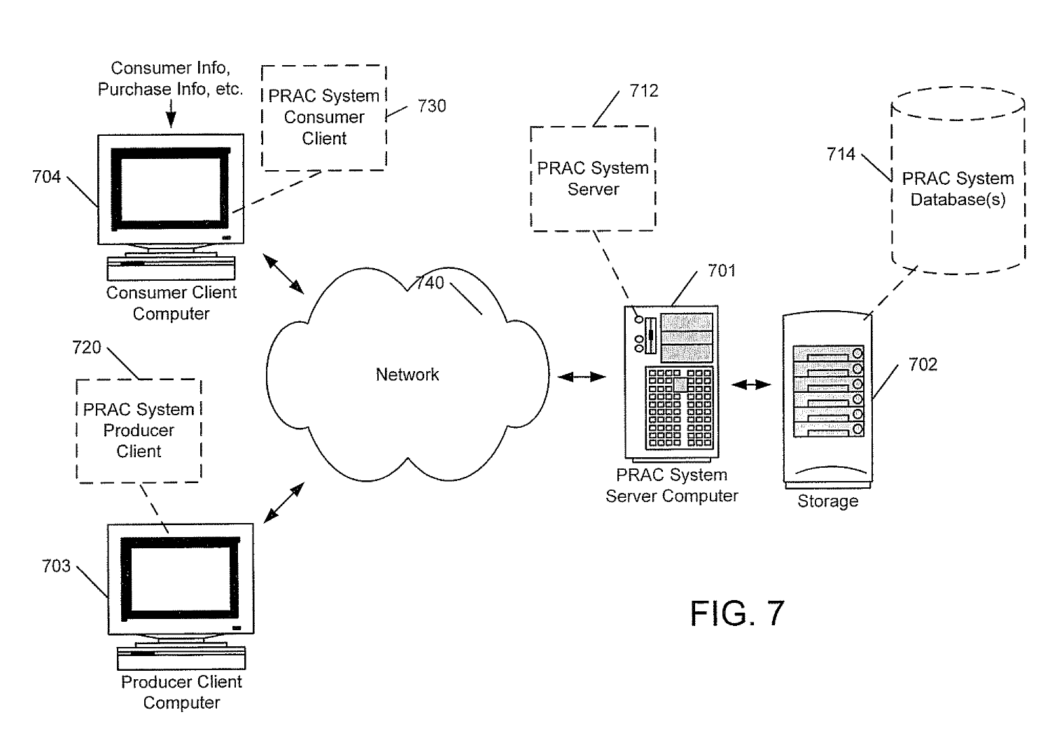

According to further embodiments of the present invention, a PRAC may be offered and executed outside of, e.g., before or after, a sale. FIG. 7 illustrates an exemplary implementation of a PRAC system that may be advantageous, for example, for embodiments in which a PRAC is executed or modified before or after purchase of a product covered by the PRAC.

A PRAC system server 712 is implemented in a server computer 701, which is operatively associated with a data storage device 702 (e.g., a disk drive array) that stores a PRAC database 714. A consumer client computer 704, for example, a consumer's home PC, notebook computer, personal digital assistant, cellular telephone handset or the like, is coupled to the PRAC server computer 701 by an IP network 740, and has a PRAC system consumer client 730 resident thereat. The consumer client 730 may be configured to provide a man-machine interface for a consumer user to perform and/or support consumer client functions as described herein and/or may be configured to perform and/or support all or some of such consumer client functions automatically without user interaction. A provider computer 703 is coupled to the IP network 740 and has a PRAC system provider client 720 resident thereat. The provider client 720 may be configured to provide a man-machine interface for a provider user to perform and/or support provider client functions as described herein and/or may be configured to perform and/or support all or some of such provider client functions automatically without user interaction.

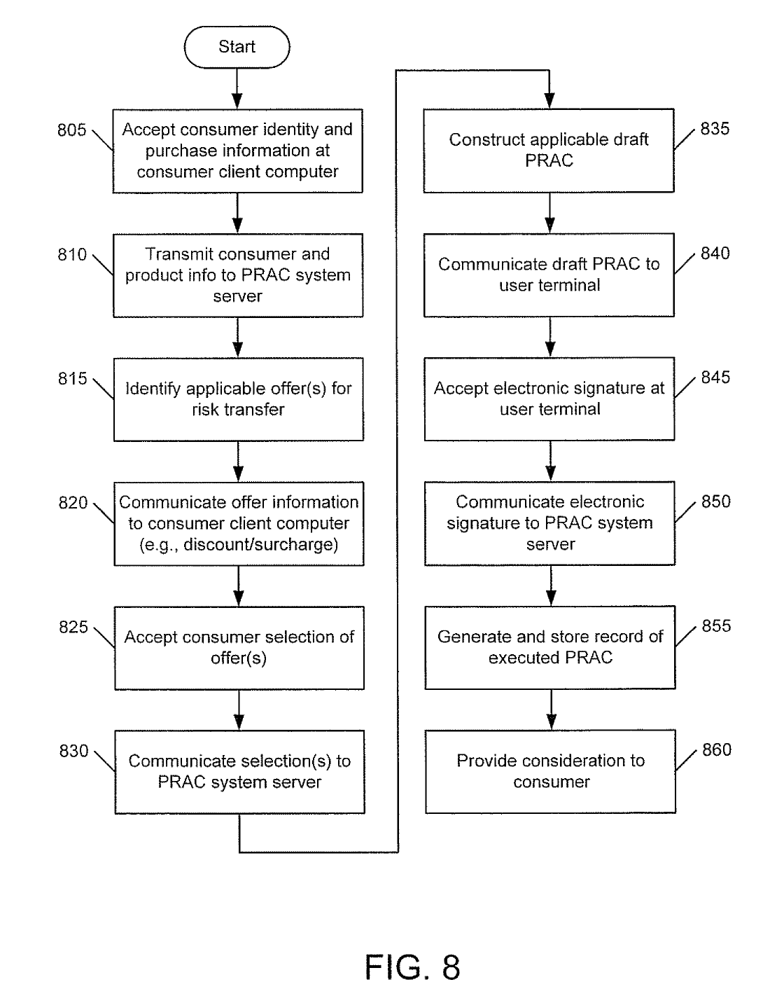

FIG. 8 illustrates exemplary operations for creating and executing a PRAC in such an environment. Consumer identity information is accepted at the consumer client computer 704, along with identification of one or more candidate products for a PRAC (block 805). The consumer information may be entered using, for example, a card swipe, biometric input (e.g., fingerprint or retinal scan), and/or entry of username and password. Such information may be used, for example, to determine whether the consumer is enrolled in PRAC service or otherwise authorized to enter into PRACs. Products may be identified, for example, by the consumer entering product serial number or other information and/or by automatic identification techniques, such as bar code scanning and RFID.

The consumer identification and product information are transmitted by the PRAC system consumer client 730 at the consumer client computer 704 to the PRAC system server 712 at the server computer 701 (block 810). The PRAC system server 712 identifies one or more applicable offers for risk transfer resident in the PRAC database 714 (block 815), and communicates information about the offer(s) to the PRAC system consumer client 730 at the consumer client computer 704 (block 820).

At the consumer client computer 704, the consumer selects the offer(s) that she wishes to accept (block 825). The selection(s) are then communicated back to the PRAC system server 712 (block 830), which constructs an appropriate PRAC, e.g., by drafting a new proposed PRAC or drafting a proposed modification of an existing PRAC (block 835). Information describing the proposed PRAC is then communicated back to the PRAC system consumer client 730 (block 840), where the consumer may formally accept the agreement by an appropriate authenticated process, such as an electronic signature (block 845). The evidence of formal acceptance may then be communicated to the PRAC system server 712 (block 850), which may responsively generate a retrievable electronic record of the executed PRAC (block 855). Consideration may then be provided to the consumer, for example, by providing a credit, rebate or payment to the consumer (block 860). For example, a rebate certificate or evidence of credit on a credit card account may be conveyed to the consumer client 730.

In some embodiments of the present invention, a third party, hereinafter referred to as a PRAC Service Provider (PSP), may maintain a PRAC service that provides functions along the lines of the server 112 shown in FIG. 1. Providers and consumers may be enrolled in the PRAC service using communications between provider and consumer clients. Products that are eligible for PRACs may be enrolled in the PRAC service. In some embodiments, certain types of third party actors may also be enrolled in the PRAC service for various validation, authorization and gate-keeping functions. Such a model may be used, for example, to support negotiation of PRACs for products such as prescription drugs, wherein verification by a third party, e.g., a pharmacist, may be required.

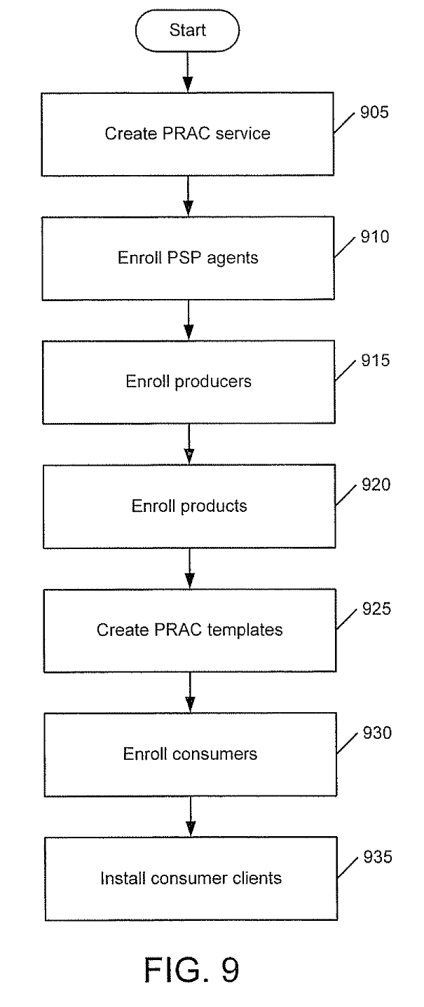

FIG. 9 illustrates operations for setup of such a PRAC service according to some embodiments of the invention. Referring to FIG. 9 in conjunction with FIG. 1, a PSP creates a PRAC system, e.g., installs and configures a server and associated hardware and software to support creation of the PRAC server 112 and PRAC database 114 (block 905). The PSP enrolls its employees, contractors or other agents, as enrolled users, i.e., users that have access to the PRAC service using, for example, user terminals coupled to the PRAC system server 112 (block 910). The PSP (e.g., via its agents) recruits providers as customers and the enrolled PSP agents enroll the providers agents (i.e., as a different class of users) (block 915). The enrolled PSP agents and/or the enrolled provider agents enroll the provider's selected products as enrolled products (block 920). This may entail entering identification information and possibly other information about the enrolled product. For example, the information may include links to websites or other network locations that provide additional information.

The enrolled provider agents and/or PSP agents also create and enter PRAC templates or other information describing liability transfer offers for the enrolled products (block 925). For example, a provider may determine that the provider's product liability insurance premiums will be lower if a substantial proportion of the provider's products are enrolled in a PRAC program. The provider could then decide to initiate a PRAC program and offer discounts to consumers who participate in the program. Alternatively, in order to cover the cost of product liability insurance, an enrolled provider might charge a surcharge for enrolled products that are acquired without participation in a PRAC program. In some embodiments, one PRAC template may cover many, or even all, of an enrolled provider's enrolled products and/or individual PRAC templates for respective enrolled products may be used, and may include information about such discounts, surcharges, preferential contract terms (e.g., an opportunity for early purchase, higher limits on numbers of items, etc.) or other forms of consideration for PRACs.

The enrolled provider may also define one or more methodologies for identifying an enrolled user with sufficient rigor so that, when an enrolled user uses the methodology for identification, a subsequent enrolled user-entered electronic signature is legally enforceable. Any of a number of different identification methodologies may be used, and different methodologies may be used for different classes of enrolled users (e.g., enrolled consumer, enrolled consumer agent, enrolled provider employee, enrolled auxiliary user). For example, the PRAC service may employ a user card similar to a credit card that has a magnetic stripe with enrolled user identification information. This might be supplemented by a password or personal identifier number (“PIN”) and/or biometric information captured as part of the consumer enrollment process. Generally, the provider, via the provider client 120, may define the context and content by which PRACs are to be offered and executed by the PRAC service. Thus, for example, each provider may define the process by which PRACs are offered and executed. The definition of the process may depend, for example, on the types of products covered and/or the level and/or types of risk the provider is willing to tolerate.

Still referring to FIG. 9, the PSP and/or the enrolled provider and/or PSP may enroll consumers (block 930). An enrolled provider and/or PSP may attempt to enroll many consumers well before the time when they will actually execute PRACs. Prior enrollment may provide the PSP and/or the enrolled provider with an opportunity to confirm consumer or consumer agent identification, obtain and evaluate additional information about a consumer, decide whether the PSP or enrolled provider wishes for a specific consumer to be enabled to enter PRACs, to prepare and issue identification cards or other identification equipment, and provide enrolled consumers and enrolled consumer agents with PRAC templates in order that they may pre-educated about PRACs prior to being offered the opportunity to engage in them. Alternatively or in combination with such pre-purchase enrollment, consumers may also be enrolled concomitant with purchase of an enrolled product.

Consumer clients 130 are installed or otherwise established (block 935). For example, the PSP and/or providers may contract with merchants (potential sellers, lessors, etc.) to participate in the PRAC service, and may install user terminals configured to serve as consumer clients at merchant locations, wherein the user terminals are connected to a PRAC system server via a communications network. Merchant employees may become enrolled auxiliary users who may serve to assist consumers and/or act as validators or gatekeepers for the PRAC system. For example, such auxiliary users may be personnel necessary to enable enrolled consumers or enrolled consumer agents to identify themselves and enter electronic signatures at point-of-sale or other locations where PRACs will be executed. Gatekeeper functions may include authorization of purchase of particular products, such as verification of a prescription for a drug or other medical item or verification of insurance or credit for purposes of ensuring payment.

An enrolled provider may also set the PRAC system to pre-authorize execution of PRACs for one or more enrolled products that an enrolled consumer may acquire. With pre-authorization, when a consumer or consumer agent executes a PRAC, the system may execute a PRAC on behalf of the enrolled provider without requiring contemporaneous provider interaction. A pre-authorization may be limited to a specific enrolled product, a specific class of enrolled products or all the enrolled provider's enrolled products. A pre-authorization may also be limited to a specific enrolled consumer, a class of enrolled consumers, or all enrolled consumers. Pre-authorizations may also be tailored to different sets of constraints depending on the product and/or the type of consumer. Thus, for example, a first product may be pre-authorized for PRAC execution with a specific consumer or class of consumers, while a second product may be available for PRAC processing for all enrolled consumers.

In some embodiments, an enrolled auxiliary user may log in to the PRAC system and enter information about a specific potential PRAC before the enrolled consumer attempts to acquire an enrolled product. For example, when a pharmacist who is an enrolled auxiliary user receives a prescription directly from a physician for a medication that is an enrolled product, the pharmacist may enter information about the enrolled product and the enrolled consumer into the PRAC database before the enrolled consumer arrives to obtain the enrolled product and before offering the enrolled consumer the opportunity to execute the PRAC. In other embodiments, e.g., at a supermarket or department store, a checkout clerk enrolled as an auxiliary user may scan universal product codes as a part of the sales process, and this information may be used to enter information about all enrolled products into one or more PRACs.

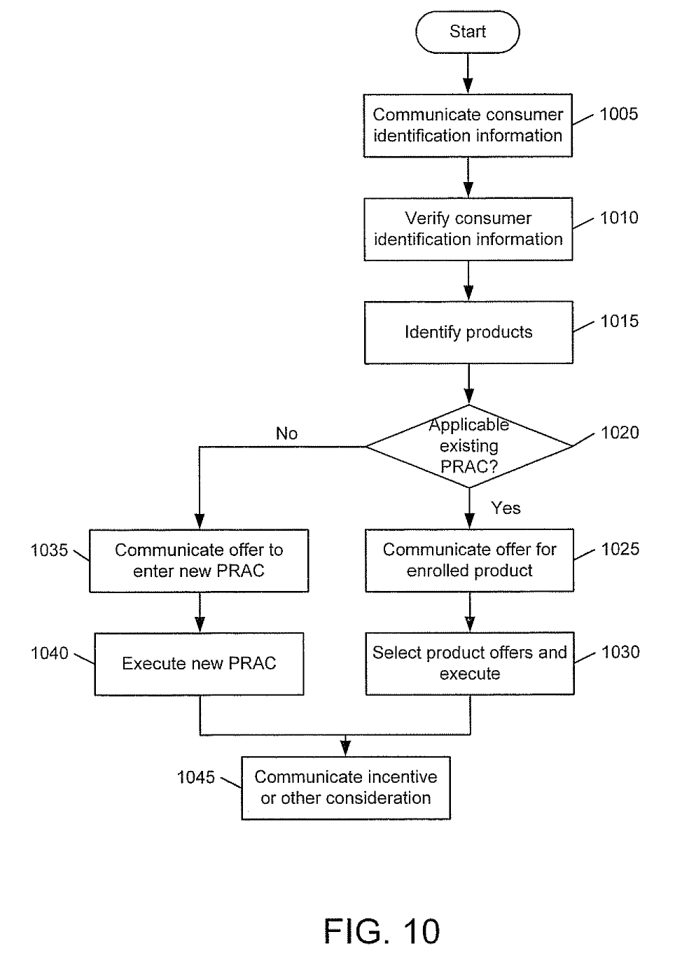

FIG. 10 illustrates exemplary operations for executing a PRAC when an enrolled consumer acquires one or more enrolled products at a participating location. The enrolled consumer uses a user terminal to communicate consumer identification information to the PRAC server (block 1005). An enrolled auxiliary party, e.g., a checkout clerk, pharmacist, dealer or the like, may be required to validate some of the identification information. The PRAC server receives and verifies the enrolled consumer identification information (block 1010). Responsive to identification of products that the consumer desires to acquire (e.g., by bar code or other scanning) (block 1015), the PRAC service may offer the enrolled consumer the opportunity to add one or more identified products to one or more previously-executed PRACs (blocks 1020, 1025). The enrolled consumer may select an identified product that the enrolled consumer wishes to add to the existing PRAC(s) and use an electronic signature to amend each PRAC to modify the PRAC to add the selected enrolled product(s) (block 1030).

For example, the consumer may view a list of enrolled products on the user terminal, and select those products for which he/she/it wishes to execute PRACs (for example, by using a computer mouse or other user input device). PRACs for the identified enrolled products may then be executed. The enrolled consumer may, for example, press a particular key or sign an electronic signature pad to execute the PRACs for the selected enrolled products. The PRAC system may execute an enrolled provider-specified procedure to decide whether to execute the PRAC for this enrolled product and enrolled consumer. The PRAC execution procedure may be continued or terminated, as appropriate. The PRAC system may determine whether the enrolled provider has pre-authorized execution of this PRAC for this enrolled product with this consumer and, if so, the PRAC system may execute the PRAC on behalf of the enrolled provider. If the enrolled provider has not pre-authorized execution of this PRAC for this enrolled product with this consumer, the PRAC system may transmit information about the PRAC, the enrolled consumer and the enrolled product to the enrolled provider (typically to an enrolled provider's computer system) and inquire whether the enrolled provider wishes to execute the PRAC for this enrolled product and enrolled consumer. If yes, the PRAC system may execute the PRAC on behalf of the enrolled provider. If not, the PRAC system may notify the enrolled consumer and terminate the process.

When one or more PRACs are executed, the PRAC system may store the PRAC in a PRAC database. The records of the executed PRAC may be formatted in any of several file formats. The system may notify the enrolled consumer via the user terminal that the PRAC has been executed and/or may provide notification via another communications medium, e.g., by e-mail to an address associated with the enrolled consumer.

After completion of the PRAC processing, the user terminal and merchant equipment may convey the enrolled provider's incentives to the enrolled consumer (block 1045). For example, if the enrolled provider offers a discount on products for which a PRAC is executed, the discount will typically be applied to the purchase price or other price of acquisition. For another example, if the enrolled provider charges a surcharge for products that are not included in a PRAC, for example to cover the cost of liability insurance, the surcharge typically will be applied to the purchase price at this time.

Still referring to FIG. 10, if the enrolled consumer is acquiring enrolled products for which there is no pre-existing applicable PRAC, the service may offer the enrolled consumer an opportunity to create a generic and/or specific PRAC for one or more enrolled products being acquired (blocks 1020, 1035). If the offer is accepted, the enrolled consumer uses an electronic signature or some other authenticated execution process to execute the new PRAC (block 1040). After execution of the new PRAC or PRAC modification, an incentive (e.g., discount, rebate, etc.) may be communicated to the enrolled consumer (block 1045). For example, if the enrolled provider offers a discount on products for which a PRAC is executed, the discount may be applied to the purchase price or other price of acquisition. In some embodiments, if the enrolled provider charges a surcharge for products that are not covered by a PRAC, for example, to cover the cost of liability insurance, the surcharge may be applied to the purchase price

When a consumer that is not an enrolled consumer makes an acquisition of an enrolled product at a participating location, an enrolled auxiliary user employed at the location may offer the consumer an opportunity to participate in the PRAC program. If the consumer decides to participate, the consumer provides the identification information required by the PRAC system, possibly including biometric information and validation by the enrolled auxiliary user, and uses the user terminal to enroll in one or more PRAC programs. The consumer becomes an enrolled consumer and proceeds in the manner described above when an enrolled consumer wishes to acquire enrolled products.

When an enrolled consumer experiences an adverse event that may be related to an enrolled product that is included in a PRAC executed by the enrolled consumer, the enrolled consumer may use a user terminal to log into the applicable PRAC system, providing applicable identification information, and review the applicable PRAC, obtain an electronic copy of the applicable PRAC (e.g., via email), and/or request that the PSP send an authenticated copy of the applicable PRAC to a specified address.

Legal actions may be constrained to comply with the terms and conditions of the applicable PRAC. For example, the applicable PRAC may limit damages the enrolled consumer can collect as a result of the tort, may provide that disputes be resolved by compulsory arbitration, and/or may preclude the enrolled consumer from participating as a plaintiff in a class action lawsuit.

When an enrolled provider receives notification from an enrolled consumer of an adverse event related to an enrolled product, the enrolled provider's agent may use a user terminal to log into the applicable PRAC service, provide applicable identification information, review the applicable PRAC, obtain an electronic copy of the applicable PRAC (e.g., via email), and/or (c) request that the PSP send an authenticated copy of the applicable PRAC to a specified address.

A record of a PRAC stored in a PRAC database may contain, for example, text describing terms of the PRAC, identification of the enrolled provider, and identification of the enrolled consumer and/or the enrolled consumer agent who executed the PRAC. Each time the PRAC is executed for a specific enrolled product, the PRAC, as stored in the PRAC database, may include an identification of the enrolled product, the enrolled consumer's electronic signature that executed the PRAC in this instance, with date and time of execution, the enrolled provider's or enrolled provider employee's electronic signature with date and time of execution, and ancillary information (e.g., location of the terminal used by the enrolled consumer).

The actual data structure used to store PRAC information in a PRAC database can vary. For example, in a relational database, the identification information and other information for each enrolled consumer or enrolled consumer agent may be stored once in a relational table, with similar storage for each enrolled provider, each enrolled product, the text of the PRAC, or PRAC template, etc. In such a case, a specific PRAC may include a relation that links rows from multiple tables. Alternative PRAC storage schemas may be used as, for example, storing each execution of each PRAC as a complete, separate record in a flat file database.

An enrolled user can use a terminal, such as a personal computer with internet browser software, to log into a PRAC system. As a pail of the login procedure the PRAC system may require the enrolled user to provide identification similar to that used to execute a PRAC. After confirming an enrolled user's identity the PRAC system may log the enrolled user in and provide access to information and services.

Among other things, the system may permit an enrolled user to retrieve (and print, if supported by the user terminal) a list of the PRAC system's enrolled providers and any enrolled provider's PRAC templates, to access information provided by an enrolled provider, such as for example, information about its enrolled products, PRAC program, PRAC templates, safety information, and product recall information. The system may also allow a user to send a message, e.g., via email, to an enrolled provider regarding a specific PRAC, the enrolled provider's PRAC system and/or the enrolled provider's enrolled products.

In addition to the services provided to all enrolled users, a PRAC system may provide an enrolled consumer with the ability to retrieve lists of all of the PRACs executed by the enrolled user, a list of all enrolled products included in the PRACs, and the date and time each enrolled product was added to a PRAC. The consumer user may also be enabled to send (e.g., via email) a file containing a copy of any of the enrolled user's executed PRACs to the enrolled user (e.g., at the enrolled user's email address stored in the PRAC database). The file containing an executed PRAC may be formatted in any of several file formats. A consumer user may also be enabled to send a message (e.g., via email) to an enrolled provider regarding a specific PRAC, the enrolled provider's PRAC system, or the enrolled provider's enrolled products.

An enrolled auxiliary user may be enabled to retrieve a list of all of the PRACs in which the enrolled auxiliary user participates. For example, if the enrolled auxiliary user is a pharmacist who participates in enrolling consumers into a PRAC program the pharmacist may obtain a list of all PRACs in which he/she was involved, sort the list in various ways (e.g., by enrolled consumer name or ID, by date, etc.), and filter the list (specify criteria for selecting a subset of the PRACs listed). The auxiliary user may also send (e.g., via email) files containing a copy of any executed PRAC that the enrolled auxiliary user helped execute, to the enrolled ancillary person (e.g., at the enrolled ancillary person's email address stored in the PRAC database). The file containing an executed PRAC may be formatted in any of several file formats.

An enrolled provider may be enabled to retrieve a list of the enrolled provider's PRAC templates, and PRACs. The enrolled provider may be enabled to sort such a list on one or more fields (e.g., identification fields) and/or filter the list. The provider may also send files (e.g., via email), each containing a copy of any executed PRAC, to an enrolled provider (e.g., at the enrolled provider's email address stored in the PRAC database). The file containing an executed PRAC may be formatted in any of several file formats. The provider may also be enabled to send a message (e.g., via email) to an enrolled consumer regarding a specific PRAC, the enrolled provider's PRAC system and/ or the enrolled provider's enrolled products. An enrolled provider may also access information provided by an enrolled consumer, such as, for example, email address, postal address, and other information.

According to further embodiments of the present invention, modifications of the above-described techniques for creating and executing PRACs may be used for other types of products. For example, a substantial proportion of the sales price of a new general aviation aircraft may be attributable to the airplane and airplane component manufacturers' insurance and other financial provisions for product liability. According to some embodiments of the present invention, PRACs may be entered for general aviation aircraft and/or components thereof. Use of such PRACs may permit general aviation aircraft and aircraft component manufacturers to transfer legal and financial responsibility for adverse events to aircraft owners. Along with the basic PRAC features discussed above, such a service may further include hardware and procedures to monitor and/or control compliance with PRACs.

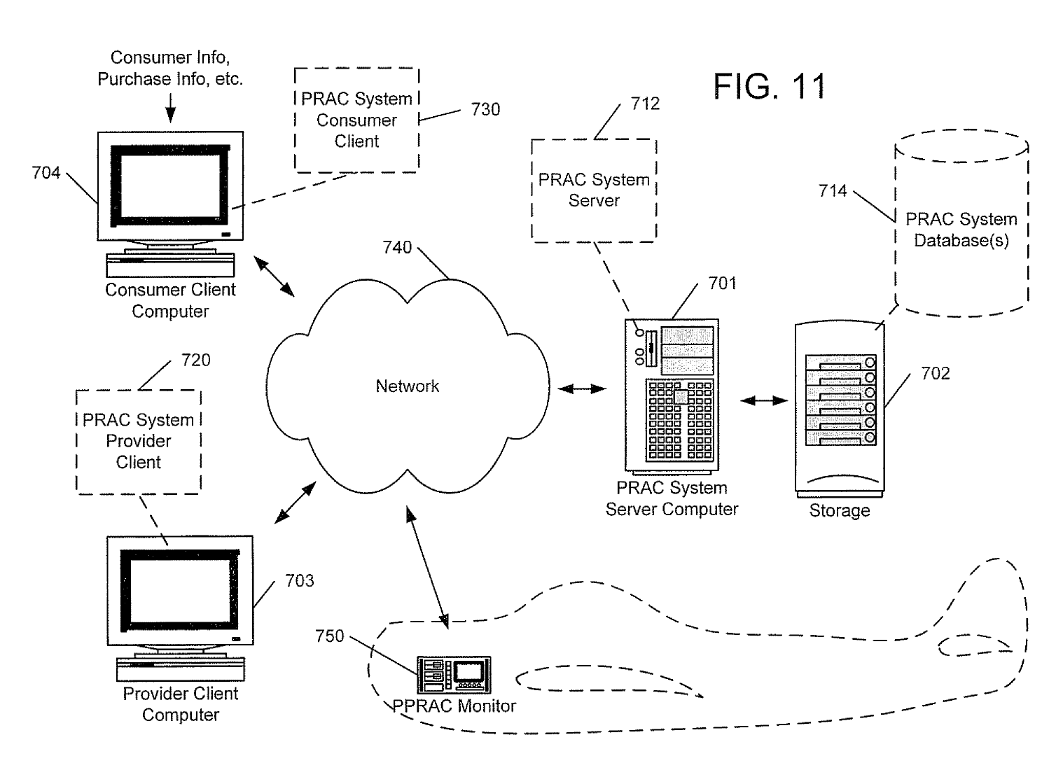

FIG. 11 illustrates components that might be used in a general aviation aircraft (GAA) PRAC service according to some embodiments of the present invention. Several of the components may have similar functionality to that described above with reference to FIG. 7. Such like components indicated by like references numerals, and will not be discussed in further detail in light of the foregoing discussion of FIG. 7.

To provide additional functionality for monitoring and/or enforcement of a GAA PRAC, the system in FIG. 11 further includes a PRAC monitor 750 that is positioned in an aircraft. The PRAC monitor 750 is configured to provide PRAC-based monitoring and/or control functions as described below. In various embodiments of the present invention, for example, the PRAC monitor 750 may be configured to communicate with the PRAC system server 712 to receive information relating to a PRAC for the product (here, an aircraft). In some embodiments, the PRAC monitor 750 may monitor and/or control operation of the product in conjunction with the PRAC system server and/or may also autonomously monitor and/or control operation of the product based on PRAC information received contemporaneously and/or previously from the PRAC system server 712. It will be understood that, in some embodiments, the PRAC monitor 750 may communicate with the PRAC system server 712 via, for example, a communications network, as shown in FIG. 11. In further embodiments, however, the communications may occur using other media, such as by transfer of information via a transportable memory device, such as an optical or magnetic disk or non-volatile memory device (e.g., a USB flash key, smart card, or other portable memory device), such that the PRAC monitor 750 controls and/or monitors the product responsive to PRAC information stored in the transportable memory device.

Creation of a PRAC service for such equipment may include similar procedures to those described above for other types of PRACs. A PSP may create a general aviation aircraft (GAA) PRAC service, which may use computer software, computer hardware, computerized procedures, and manual procedures substantially similar to that discussed above. The GAA PRAC service may further include additional specialized hardware, software and operations tailored to use of PRACs in the general aviation market. For example, in some embodiments, a new aircraft that is a GAA enrolled product may have installed equipment that effectively allows the GAA PRAC system to enforce certain terms of the GAA PRAC.

GAA PRACs may be formed between enrolled GAA component providers and enrolled GAA providers. Each time an enrolled GAA provider purchases GAA enrolled products from an enrolled GAA component provider, the two parties may use the PSP's PRAC system to execute a GAA PRAC under which the GAA provider accepts the risks associated with the acquired enrolled GAA products.

This transfer of responsibility can take various forms. For example, the enrolled GAA provider can assume the responsibilities directly, indemnifying the enrolled GAA component provider from all damages. Alternatively, for example, the enrolled GAA provider may accept responsibility for selling aircraft containing the enrolled GAA products only to enrolled GAA consumers that execute GAA PRACs under which the purchasers accept risks associated with all components of the aircraft and indemnify the enrolled GAA component provider. Using this procedure enrolled GAA component providers can significantly reduce their product liability exposure and therefore reduce the cost of enrolled GAA products that are components.

A PSP may wish to enroll GAA consumers prior to the time they attempt to acquire an aircraft. Pre-enrollment of GAA consumers may provide similar benefits as pre-enrolling ordinary (non-GAA) consumers. The procedures for pre-enrolling GAA consumers may be substantially the same as the procedures for pre-enrolling non-GAA consumers discussed above. Enrolled GAA consumers, however, may need to accept additional preflight restrictions, as described below.

An enrolled GAA consumer acquiring a new or used aircraft component may use the PRAC service to execute a GAA PRAC as a part of the aircraft component acquisition process, using a user terminal at a point of sale or other location. The GAA PRAC service may use substantially the same processes used in other PRACs to confirm the identity of the enrolled GAA PRAC consumer and validate this enrolled consumer's electronic signature. The GAA PRAC service may obtain the enrolled GAA provider's electronic signature using the same procedures used for general PRACs. The GALA PRAC service, having acquired the GAA PRAC and the parties' electronic signatures, may store the GAA PRAC in the PRAC database in the same manner as it stores other PRACs. The PRAC service may provide all the services available for general PRACs to GAA PRAC clients.

The sale, lease, or other transfer of a used aircraft under such a scheme may be different from the transfer of a new aircraft in a number of ways. An important potential difference is that the “disposer” (seller, leaser, etc.) may be an enrolled GAA consumer who executed a GAA PRAC when she acquired the aircraft. For the transfer now being considered, the disposer may wish that the “acquirer” (buyer, leaser, etc.) execute a GAA PRAC under which the acquirer accepts risks associated with the aircraft. The PSP may provide a GAA PRAC template for the transfer (sale, lease, etc.) of one or more general aviation aircraft from one enrolled GAA consumer to another.

The disposer, an enrolled GAA consumer that is disposing of the aircraft (selling, leasing, etc.), may use a user terminal to access the PRAC system and identify the aircraft (which is/are enrolled GAA product(s)), copy aircraft identification information from the PRAC database into the GAA PRAC template, identify the parties and copy disposer and acquirer identification information from the PRAC database into the GAA PRAC template, and insert additional information about the transfer into the GAA PRAC template, which now becomes a GAA PRAC ready for execution. The GAA PRAC service may use substantially the same procedures available via the general PRAC system to confirm the identity of the disposer enrolled GAA consumer and validate this enrolled consumer's electronic signature. The acquirer, an enrolled GAA consumer that is acquiring (buying, leasing, etc.) the aircraft, may use a user terminal to access the PRAC system, retrieve the used-aircraft-transfer GAA PRAC already executed by the disposer and execute this GAA PRAC. The GAA PRAC service may use processes available via the general PRAC system to confirm the identity of the Acquirer enrolled GAA consumer and validate this enrolled consumer's electronic signature.

The GAA PRAC system, having acquired the GAA PRAC and the parties' electronic signatures, may store the GAA PRAC in the PRAC database in the same manner as it stores other PRACs. The PRAC system may provide substantially the same services available for general PRACs to GAA PRAC clients. In addition, an acquirer enrolled auxiliary user (such as the acquirer or an employee or representative of the acquirer) may activate the aircraft's PRAC monitor (e.g., the PRAC monitor 750 shown in FIG. 11), which accesses the GAA PRAC database. The PRAC system may update information stored in the PRAC monitor's local data storage. The acquirer and/or an enrolled auxiliary user may also enter additional information requested by the PRAC monitor. Generally, the PRAC monitor may be used to monitor and/or ensure that operation of the aircraft occurs in accordance with the GAA PRAC.

The details of how GAA PRAC compliance may be monitored/controlled may vary from one enrolled GAA provider to another, from one product to another, and over time. In some implementations, after initiation of a new GAA PRAC for a specific aircraft, the PRAC monitor of an aircraft may request information, such as the date the aircraft was originally put into service, dates, descriptions, of all aircraft alterations or aircraft or powerplant rebuildings, and identifications (names, certificate numbers) of FAA certified mechanics who performed the work and who authorized return to service. Information may be required for each alteration or rebuilding of the airframe, engine(s), propeller(s), and each “appliance” as defined by government regulations. Other information may include date of the most recent annual inspection, if any, and identification(s) (e.g., names, certificate numbers, and/or electronic signatures) of FAA certified mechanic(s) who performed the work and who authorized return to service. Additional information may include the date of the most recent 100-hour inspection, if any, and identification(s) (e.g., names, certificate numbers, and/or electronic signatures) of FAA certified mechanic(s) who performed the work and who authorized return to service.

Further information may include the date of the most recent ATC transponder test and inspection, if any, and identification of the certified repair shop that performed the work. Information requested may also include the numbers of hours each engine has operated since the aircraft was initially placed in service, the engine was installed or had major repair work (e.g., rebuilt, overhauled, top overhaul). Miscellaneous other information may include the number of seats in the aircraft, which seats have occupant sensing devices, identification and date of each airworthiness directive (AD) FAA has issued for the aircraft along with date of compliance with the AD and identifications (e.g., names, certificate numbers, and/or electronic signatures) of FAA certified mechanics who performed the work and who authorized return to service. The aircraft manufacturer may enter information about ADs in the PRAC database shortly after they are issued. The aircraft operator may enter information about compliance with ADs. Addition information may include identification of all pilots and copilots authorized to fly the aircraft, wherein each authorized pilot being an enrolled auxiliary user.

A GAA PRAC may require, prior to operation of the aircraft, that information regarding a proposed flight be entered into the GAA PRAC system. Some of this information may be entered via a user terminal prior to boarding the aircraft. In particular, prior to the flight, the aircraft the pilot may activate the aircraft's PRAC monitor and download information from the GAA PRAC database. Alternatively, the pilot (or other enrolled personnel) may access the PRAC monitor (either directly or through a remote network connection), enter the information into the PRAC monitor, and upload the information to the GAA PRAC database. The required information may include: information in the flight plan filed with the FAA for a flight (i.e., the PRAC may require that all flights in GAA PRAC-covered aircraft be conducted in accordance with a flight plan filed with the FAA); information necessary to perform weight and balance calculations for the flight; and/or identification of all persons who will be on board during the flight. For example, the GAA PRAC may require that all persons who board a GAA PRAC-covered aircraft for flight must (a) be GAA PRAC enrolled auxiliary users or enrolled consumers and (b) execute a GAA PRAC accepting risk from the time they board the aircraft until they leave the aircraft.

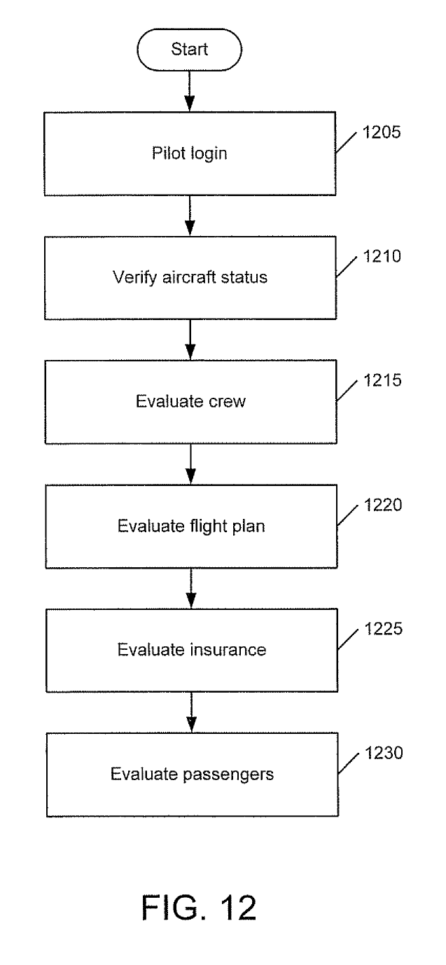

FIG. 12 illustrates exemplary operations that may be performed by and/or in conjunction with a PRAC monitor to verify compliance with a GAA PRAC. The pilot may log in to the GAA PRAC system via the PRAC monitor using procedures along lines discussed above for access to a PRAC system (block 1205). If the pilot in command fails to log in successfully, the PRAC monitor may notify the pilot in command and prevent and/or restrict operation of the aircraft. After the pilot is successfully logged in, the PRAC monitor may then evaluate status of the aircraft, crew, flightplan, insurance, passengers and other items to verify that terms of the PRAC are met before enabling the aircraft for a flight.

The PRAC monitor may verify aircraft status for conformance with the PRAC (block 1210). If, for example, weight or balance results are outside the aircraft's weight or balance profiles, the PRAC monitor may notify the pilot in command and prevent and/or restrict operation of the aircraft. The PRAC monitor may also, for example, use information from the flight plan to compute whether the fuel on board is adequate for the proposed flight, including any required reserves after arrival at the proposed destination. To perform this function the PRAC monitor may access a service, such as the Direct User Access Terminal System (DUATS), that provides flight planning and weather reporting services including winds aloft. Such access may be provided, for example, via a wireline or wireless connection to a communications network. If the fuel on board fails to meet criteria specified in the GAA PRAC for this aircraft, the PRAC monitor may notify the pilot and prevent and/or restrict aircraft operation until the deficiency is resolved.

The PRAC monitor may also check to verify that inspections and tests have been performed within specified time intervals. For example, the PRAC monitor may determine whether more than one year has passed since the most recent annual inspection. If a required inspection or test has not been performed within the required time interval the PRAC monitor may prevent and/or restrict operation of the aircraft.

The PRAC monitor may also check whether there are any unresolved airworthiness directives and, if so, whether the time intervals for their resolution have expired. For example, if there is at least one outstanding airworthiness directive that has not been resolved within the required time limit, the PRAC monitor may prevent and/or restrict operation of the aircraft.

The PRAC monitor may also evaluate characteristics of the crew to ensure compliance with the GAA PRAC (block 1215). For example, the PRAC monitor may check the expiration dates of the FAA Medical Certificates of all required crew members, such as the pilot. If the FAA Medical Certificate of any required crew member has expired, for example, the PRAC monitor may prevent and/or restrict operation of the aircraft.

The PRAC monitor may also determine whether the proposed flight plan is in accordance with PRAC terms (block 1220). For example, the PRAC monitor may estimate the time of arrival at the destination airport and determine whether the arrival will be at night. If so, the PRAC monitor may access the pilot's records and determine whether the pilot in command is qualified for a night landing. If the landing is projected to be at night and the pilot in command is not qualified for a night landing, the PRAC monitor may prevent and/or restrict aircraft operation.

The PRAC monitor may also access a flight planning and weather reporting service (e.g., DUATS) to determine if instrument flight rules (IFR) apply to this flight. If IFR apply or if the flight plan is an instrument flight plan, the PRAC monitor may check whether the pilot in command is instrument rated and qualified for instrument approaches. If the pilot in command is not instrument rated or is instrument rated but not current for instrument approaches, the PRAC monitor may prevent and/or restrict aircraft operation.

The PRAC monitor may also determine whether the aircraft is properly insured (block 1225). For example, the PRAC monitor may access the GAA PRAC database to determine the status of insurance policies covering the aircraft and the pilot in command. If any of the insurance policies is deficient (e.g., expired, cancelled) the PRAC monitor may prevent and/or restrict aircraft operation.

The PRAC monitor may also determine whether the passengers are in accordance with PRAC terms (block 1230). The PRAC monitor may, for example, require each person on board to identify himself/herself to the GAA PRAC system via the PRAC monitor using authorization/validation techniques along the lines discussed above for enrolled users. For example, if at least one occupant fails to successfully identify himself/herself as a GAA PRAC enrolled auxiliary user or enrolled consumer, the PRAC monitor may notify the pilot in command and prevent and/or restrict operation of the aircraft. The PRAC monitor may compare the identifications of persons on board with the previous information about occupants and verify that each occupant has been properly identified and has executed a GAA PRAC for this flight. For example, if at least one occupant has not executed a GAA PRAC for this flight, the PRAC monitor may notify the pilot in command and prevent and/or restrict operation of the aircraft. In some embodiments, the PRAC monitor may also compare the information from occupant sensing devices with the number of persons who have executed a GAA PRAC for this flight. If the number of occupied seats is greater than the number of persons who have executed a GAA PRAC for this flight, the PRAC monitor may notify the pilot in command and prevent and/or restrict operation of the aircraft.

It will be understood that the operations described above with reference to FIG. 12 are provided for purposes of illustration, and that the types of operations performed may generally depend on the terms of the GAA PRAC covering operation of the aircraft. Generally, a PRAC monitor may check any matter pertaining to the aircraft, crew and/or passengers as regards compliance with laws, Federal Aviation Regulations, insurance, or other matters specified in the relevant GAA PRAC. If the flight would violate any conditions of the relevant GAA PRAC, the PRAC monitor may prevent and/or restrict operation of the aircraft.

A PRAC monitor may prevent and/or restrict aircraft operation of an aircraft using, for example, an engine start interlock device that prevents the aircraft's engine(s) from being started until all issues identified by the PRAC monitor and the GAA PRAC database have been resolved. It will be appreciated, however, that other techniques may be used to prevent unauthorized operation, such as messages transmitted to security or regulatory personnel or others who may be empowered to prevent and/or restrict operation of the aircraft.

In some embodiments, a GAA PRAC may allow an enrolled GAA consumer that acquired an aircraft to obtain a waiver from the party that provided the aircraft for exceptions to the above monitoring procedures under special circumstances. For example, if the time limit for an aircraft annual inspection has expired and the aircraft must be ferried to a different airport for the inspection, the party that provided the aircraft may agree to waive the restriction for the purpose of the ferry flight. In such a case, for example, both parties may use the GAA PRAC system to execute (affix their electronic signatures to) a GAA PRAC amendment waiving the prohibition of engine start for the specific flight. Either the PSP or enrolled GAA provider may provide a GAA PRAC amendment template that is completed for this purpose.

A GAA PRAC may further provide for training flights in which an instructor with an FAA Instructor Rating accompanies a “trainee” aircraft pilot. The instructor may have executed a GAA PRAC for the flight. In such a case, one or more of the conditions described above may be waived. For example, the trainee pilot may not be required to be current for night landings or for IFR approaches.

It will be appreciated that similar techniques to those described for a GAA PRAC for general aviation may be used with other types of equipment. For example, restricted operation according to a PRAC could be employed for vehicles, marine vessels, farm or construction equipment, and the like. Such techniques may be applied for purchased equipment as well as for equipment operated under lease.

Certain embodiments of the present invention are described herein with reference to flowchart and/or block diagram illustrations of methods, apparatus and/or computer program products in accordance with some embodiments of the invention. These flowchart and/or block diagrams further illustrate exemplary operations in accordance with various embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Many variations and modifications can be made to the embodiments without substantially departing from the principles of the present invention. All such variations and modifications are intended to be included herein within the scope of the present invention, as set forth in the following claims.

That which is claimed:

1. A method of supporting risk management for products, the method comprising the following operations performed by a product risk acceptance contract (PRAC) system server in a data communications network:
communicating with a PRAC system provider client coupled to the PRAC system server and responsively generating a record of an offer for a risk transfer for a product; and
communicating with a PRAC system consumer client coupled to the PRAC system server and responsively generating a record of an executed PRAC for the product based on the generated record of the offer for the risk transfer.

2. The method of claim 1, wherein communicating with a PRAC system consumer client coupled to the PRAC system server and responsively generating a record of an executed PRAC for the product based on the generated record of the offer for a risk transfer comprises:
transmitting information describing the offer for a risk transfer to the PRAC system consumer client;
subsequently receiving risk transfer acceptance information from the PRAC system consumer client; and
generating the record of the executed PRAC responsive to receipt of the risk transfer acceptance information.

3. The method of claim 2, wherein transmitting information describing the offer of a risk transfer is preceded by:
receiving information from the PRAC system consumer client identifying at least one candidate product;
identifying the record of the offer for a risk transfer based on the identified candidate product; and
generating the information describing the offer for a risk transfer responsive to identification of the offer for a risk transfer.

4. The method of claim 2, wherein the information describing the offer for a risk transfer comprises information describing consideration associated with acceptance of the offer.

5. The method of claim 4, wherein the consideration comprises a discount, a surcharge and/or a rebate, and/or preferential contract terms.

6. The method of claim 2, wherein the information describing the offer for a risk transfer comprises information identifying a known type of potential adverse event associated with the product, and wherein the risk transfer comprises a waiver of a legal remedy for the identified type of potential adverse event.

7. The method of claim 2, wherein the information describing the offer for a risk transfer comprises information identifying a known type of potential adverse event associated with the product, and wherein the risk transfer comprises a waiver of a legal remedy for an unidentified type of potential adverse event associated with the product.

8. The method of claim 2, wherein the information describing the offer for a risk transfer comprises information identifying a type of potential adverse event associated with the product known from regulatory agency mandated testing of the product, and wherein the risk transfer comprises a waiver of a legal remedy for a type of potential adverse event unidentified by regulatory agency mandated testing of the product.

9. The method of claim 1:
wherein communicating with a PRAC system provider client coupled to the PRAC system server and responsively generating a record of an offer for a risk transfer for a product of a provider comprises:
receiving PRAC term information from the PRAC provider client; and
generating a PRAC template based on the received PRAC term information; and
wherein communicating with a PRAC system consumer client coupled to the PRAC system server and responsively generating a record of an executed PRAC for the product based on the generated record of the offer for a risk transfer comprises:
receiving PRAC component information from the PRAC system consumer client; and
entering the received PRAC component information into the PRAC template.

10. The method of claim 1, wherein communicating with a PRAC system consumer client coupled to the PRAC system server and responsively generating a record of an executed PRAC for the product based on the generated record of the offer for a risk transfer comprises communicating with the PRAC system consumer client and responsively generating a record of an executed modification of a previously executed PRAC.

11. The method of claim 1, wherein communicating with a PRAC system consumer client coupled to the PRAC system server and responsively generating a record of an executed PRAC for the product based on the generated record of the offer for a risk transfer comprises:
receiving a electronic signature from the PRAC system consumer client; and
generating the record of the executed PRAC responsive to receipt of the electronic signature.

12. The method of claim 1:
wherein communicating with a PRAC system provider client coupled to the PRAC system server and responsively generating a record of an offer for a risk transfer for a product of a provider is preceded by communicating with a PRAC system provider client to enroll a provider in a PRAC service; and
wherein communicating with a PRAC system consumer client coupled to the PRAC system server and responsively generating a record of an executed PRAC for the product based on the generated record of the offer for a risk transfer is preceded by communicating with a PRAC system consumer client to enroll a consumer in the PRAC service.

13. The method of claim 12:
wherein communicating with a PRAC system consumer client to enroll the consumer in the PRAC service is preceded by:
receiving information from the PRAC system consumer client identifying at least one candidate product; and
identifying the record of the offer for a risk transfer as corresponding to the identified candidate product; and
wherein communicating with the PRAC system consumer client to enroll a consumer in the PRAC service comprises communicating with a PRAC system consumer client to enroll the consumer in the PRAC service responsive to identification of the record of the offer for a risk transfer as corresponding to the identified candidate product.

14. The method of claim 12, wherein communicating with a PRAC system consumer client coupled to the PRAC system server and responsively generating a record of an executed PRAC for the product based on the generated record of the offer for a risk transfer comprises:
receiving validation information from the PRAC system consumer client; and
generating the record of the executed PRAC responsive to the validation information.

15. The method of claim 14, wherein the validation information comprises biometric information associated with the enrolled consumer, account information associated with the enrolled consumer and/or information associated with a enrolled validator for the PRAC service.

16. The method of claim 1, wherein communicating with a PRAC system consumer client coupled to the PRAC system server and responsively generating a record of an executed PRAC for the product based on the generated record of the offer for a risk transfer comprises communicating with the PRAC system consumer client and responsively generating a record of the executed PRAC concomitant with sale of the product to the consumer.

17. The method of claim 1, wherein communicating with a PRAC system consumer client coupled to the PRAC system server and responsively generating a record of an executed PRAC for the product based on the generated record of the offer for a risk transfer comprises communicating with the PRAC system consumer client and responsively generating a record of the executed PRAC concomitant with provision of a payment and/or credit to the consumer.

18. The method of claim 1, wherein communicating with a PRAC system consumer client coupled to the PRAC system server and responsively generating a record of an executed PRAC for the product based on the generated record of the offer for a risk transfer comprises:
receiving validation information from the PRAC system consumer client; and
generating the record of the executed PRAC responsive to the validation information.

19. The method of claim 18, wherein the validation information comprises biometric information, account information and/or information associated with a registered validator.

20. The method of claim 1, further comprising monitoring and/or controlling use of the product in accordance with the executed PRAC.

21. The method of claim 1, further comprising storing the record of the executed PRAC in a PRAC system database.

22. An apparatus comprising a computer configured to perform the method of claim 1.

23. A computer program product supporting risk management for products, the computer program product comprising computer program code embodied in a storage medium, the computer program code comprising program code configured to perform the method of claim 1.

24. A method of supporting risk management for products, the method comprising the following operations performed by a product risk acceptance contract (PRAC) system client in a data communications network:
receiving information describing an offer for a risk transfer for a product of a provider from a PRAC system server coupled to the PRAC system consumer client; and
responsive to the received information describing an offer for a risk transfer, communicating with the PRAC system server to support generation of a record, accessible via the PRAC system server, of an executed PRAC for the product.

25. An apparatus comprising a computer configured to perform the method of claim 24.

26. A computer program product supporting risk management for products, the computer program product comprising computer program code embodied in a storage medium, the computer program code comprising program code configured to perform the method of claim 24.

27. A method of supporting risk management for products, the method comprising the following operations performed by a product risk acceptance contract (PRAC) system provider client in a data communications network:
communicating with a PRAC system server coupled to the PRAC system provider client to support generation of a record, accessible via the PRAC system server, of an offer for a risk transfer for a product.

28. An apparatus comprising a computer configured to perform the method of claim 27.

29. A computer program product supporting risk management for products, the computer program product comprising computer program code embodied in a storage medium, the computer program code comprising program code configured to perform the method of claim 27.

30. A method of supporting risk management for a product, the method comprising the following acts performed by a product risk acceptance contract (PRAC) monitor operatively associated with the product:
controlling and/or monitoring operation of the product responsive to a PRAC for the product.

31. The method of claim 30, wherein controlling and/or monitoring operation of the product comprises operating the PRAC monitor independently of the PRAC system server to control and/or monitor operation of the product responsive to the PRAC for the product.

32. The method of claim 30, wherein controlling and/or monitoring operation of the product comprises communicating with a PRAC system server to control and/or monitor operation of the product.

33. The method of claim 32, wherein controlling and/or monitoring operation of the product comprises controlling and/or monitoring operation of the product based on PRAC information received contemporaneously and/or previously from the PRAC system server.

34. The method of claim 30, wherein controlling and/or monitoring operation of the product comprises controlling and/or monitoring operation of the product responsive to PRAC information stored in a portable memory device.

35. An apparatus comprising a computer configured to perform the method of claim 30.

36. A computer program product supporting risk management for products, the computer program product comprising computer program code embodied in a storage medium, the computer program code comprising program code configured to perform the method of claim 30.
